(19) United States
(12) Patent Application Publication
(10) Pub. No.: US 2025/0390257 A1
(43) Pub. Date: Dec. 25, 2025

(54) NON-TRANSITORY COMPUTER-READABLE STORAGE MEDIUM STORING INSTRUCTIONS IMPLEMENTING SUPPORTING PROGRAM

(71) Applicant: BROTHER KOGYO KABUSHIKI KAISHA, Nagoya (JP)

(72) Inventors: Kenju NARITA, Nagoya (JP); Yushi ICHIKAWA, Nagoya (JP); Yoshito HOSOMIZO, Konan (JP); Airi EGUCHI, Ichinomiya (JP)

(21) Appl. No.: 19/304,891

(22) Filed: Aug. 20, 2025

Related U.S. Application Data
(63) Continuation of application No. PCT/JP2024/005602, filed on Feb. 16, 2024.

(30) Foreign Application Priority Data
Feb. 21, 2023 (JP) 2023-025149

(51) Int. Cl. G06F 3/12

(52) U.S. Cl. CPC G06F 3/121; G06F 3/1228; G06F 3/1234

(57) ABSTRACT

A supporting program for a printer, when executed by a controller of an information processing device having an operating system with a universal printing program and an application program, the supporting program causing the information processing device to perform, in response to the universal printing program receiving a print instruction from the application program, causing the printer to print an image; receive an error event from the universal printing program. The error event is output in response to the universal printing program receiving an error notification from the printer after printing. The supporting program causes the information processing device to perform obtaining an error type included in the error event, the error type indicating a printer error, obtaining error screen information based on the error type, and displaying, on a user interface of the device, an error notification screen based on the error screen information.

### REFERENCE TO RELATED APPLICATIONS

This is a continuation application of International Application No. PCT/JP2024/005602 filed on Feb. 16, 2024, which claims priority from Japanese Patent Application No. 2023-025149 filed on Feb. 21, 2023. The entire contents of the aforementioned applications are incorporated herein by reference.

### BACKGROUND ART

Some known techniques have been developed for controlling a printer using an OS-standard universal printing program that is part of an operating system (OS), without a printer driver provided by a printer vendor. More specifically, for example, in response to detecting a printer, the OS may establish association between the printer and the OS-standard universal printing program. Thereafter, in response to the OS receiving a print instruction for the printer, the OS-standard universal printing program may generate print data without a printer driver provided by a printer vendor, thereby enabling printing through the OS-standard universal printing program.

For example, one technique involves performing printing via an OS-standard universal printing program. More specifically, a supporting program activated by the universal printing program in response to a print instruction repeatedly obtains status information from a printer, and passes the obtained status information to an editing application.

### SUMMARY

If an error occurs in the printer after an information processing device transmits print data to the printer, it may be preferable that details of the error be notified via the information processing device. As described above, after a print instruction is issued, the supporting program may notify of an error that has occurred in the printer by obtaining status information from the printer. Nevertheless, the supporting program may repeatedly obtain the status information from the printer, which may result in a higher communication load on the supporting program.

According to an aspect of the disclosure, a non-transitory computer-readable storage medium for an information processing device is provided, which includes a controller and stores computer-executable instructions that are executable by the controller. The computer-executable instructions implement a supporting program for a printer connectable to the information processing device. The information processing device has an operating system including a universal printing program. The information processing device is incorporated with an application program. The supporting program, when executed by the controller, causes the information processing device to perform, in response to the universal printing program receiving, from the application program, a print instruction that causes the printer to print an image to be printed, printing processing of causing the printer to print the image to be printed; receiving processing of receiving an error event from the universal printing program, the error event being output by the universal printing program in response to the universal printing program receiving an error notification from the printer after the printing; in response to receiving the error event from the universal printing program, error type obtaining processing of obtaining an error type included in the error event, the error type indicating an error that has occurred in the printer, the error type being one of a plurality of error types; error screen obtaining processing of obtaining error screen information based on the error type; and error notification processing of displaying, on a user interface of the information processing device, an error notification screen based on the error screen information.

As described above, in response to receiving the error event, which is output by the universal printing program in response to a print instruction, the supporting program may obtain the error type of the error that has occurred in the printer and display the error notification screen based on the error type on the user interface. The supporting program thus might not need to monitor the printer after transmission of print data, thereby reducing a communication load when the error that has occurred in the printer is notified.

Apparatuses and control methods for implementing the functions of the supporting program may also have novelty and utility.

According to aspects of the disclosure, a technique may be implemented to reduce communication load when an information processing device with an OS-standard universal printing program installed notifies an error that has occurred in a printer.

### BRIEF DESCRIPTION OF THE DRAWINGS

FIG. 1 is a block diagram schematically illustrating an electrical configuration of a personal computer.

FIG. 2 is a sequence diagram illustrating an example of a print execution procedure.

FIG. 3 illustrates an example of an error notification screen.

FIG. 4 illustrates another example of the error notification screen.

FIG. 5 illustrates another example of the error notification screen.

FIG. 6 is a sequence diagram illustrating another example of the print execution procedure.

FIG. 7 illustrates another example of the error notification screen.

### DESCRIPTION

Hereinafter, a personal computer (“PC”) using a supporting program of an illustrative embodiment will be described in detail with reference to the accompanying drawings. The disclosure discloses the supporting program executed by the PC.

### First Illustrative Embodiment

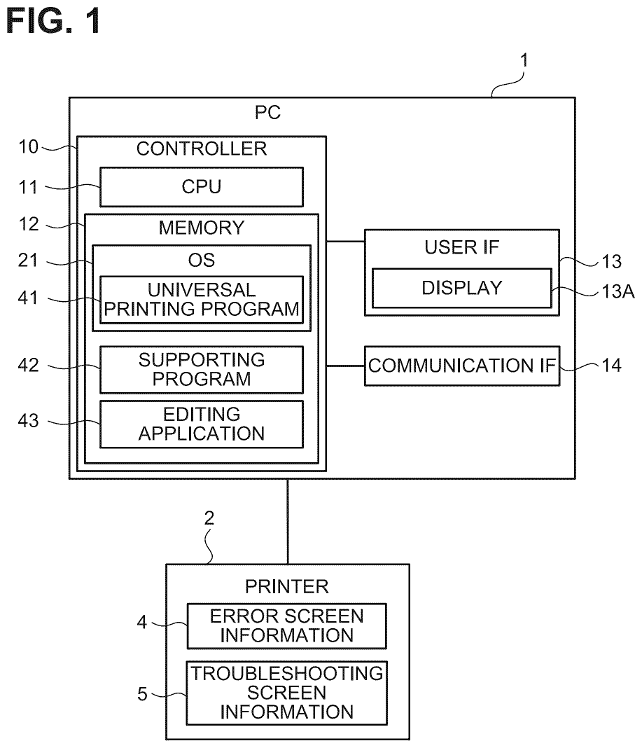

As illustrated in FIG. 1, a PC 1 of the illustrative embodiment includes a controller 10 including a CPU 11 and a memory 12. The PC 1 is an example of an information processing device. The CPU 11 is an example of a computer. The PC 1 includes a user interface (“user IF”) 13 and a communication interface (“communication IF”) 14, which are electrically connected to the controller 10. The term “controller 10” used in FIG. 1 may be a collective term for hardware and software used to control the PC 1, and might not necessarily represent a single piece of hardware actually existing in the PC 1.

The CPU 11 of the PC 1 executes various types of processing in accordance with a program read from the memory 12 or based on user input. The memory 12 stores various programs and data. The memory 12 also serves as a workspace for processing. A buffer of the CPU 11 is an example of the memory 12. Examples of the memory 12 further include storage media readable and writable by the CPU 11, for example, recording media such as CD-ROMs and DVD-ROMs, as well as a ROM, a RAM, a hard disk drive built in the PC 1.

The user IF 13 includes a display 13a, which is hardware for displaying information to a user. Further, the user IF 13 includes hardware for user input. In one example, the user IF 13 may be a combination of the display 13a and an input device, such as a mouse and/or a keyboard. In another example, the user IF 13 may be a touch screen having both display and input functions.

The communication IF 14 includes hardware that enables the PC 1 to communicate with an external device such as the printer 2. Examples of a communication standard for the communication IF 14 include Ethernet, Wi-Fi, and USB. Wi-Fi is a registered trademark of Wi-Fi Alliance. The PC 1 may be connectable to the Internet via the communication IF 14. The PC 1 may include multiple communication IFs 14 for supporting multiple communication standards.

As illustrated in FIG. 1, the memory 12 of the PC 1 stores various data and programs, including an operating system (“OS”) 21, a supporting program 42, and an editing application 43. The OS 21 includes a universal printing program 41. The supporting program 42 is an example of a supporting program. The editing application 43 is an example of an application program.

The OS 21 may be a multitasking OS that manages multiple tasks and switches between the multiple tasks, thereby handling several tasks simultaneously. The OS 21 may be, for example, Windows, macOS, Linux, iOS, or Android. Windows is a trademark of the Microsoft group of companies. macOS is a trademark of Apple Inc., registered in the U.S. and other countries and regions. Linux is the registered trademark of Linus Torvalds in the U.S. and other countries. IOS is a trademark or registered trademark of Cisco Systems, Inc. in the U.S. and other countries and is used under license. Android is a registered trademark of Google LLC.

The OS 21 includes the universal printing program 41. The universal printing program 41 is an OS-standard program that is developed by a vendor of the OS 21 and provided as part of the OS 21. The universal printing program 41 is designed to allow for the absence of printer-specific drivers.

The universal printing program 41 enables various types and models of printers provided by different vendors to perform printing based on user instructions. The universal printing program 41 supports general functions that enable various printers to perform printing. Unlike printer-specific drivers, the universal printing program 41 does not support a specific function that a printer or printer driver has, in particular, a function requiring complicated processing.

The universal printing program 41 includes a function of generating intermediate image data based on image data received as data to be printed that has been specified in a print instruction received from an application, based on a user instruction. The intermediate image data may be, for example, data in XPS format. “XPS” is an abbreviation for XML Paper Specification. The universal printing program 41 further has a function of generating print data in a format available for printing by various types of printers based on the intermediate image data. The print data may be, for example, PWG Raster data or PDF data. The universal printing program 41 further has a function of transmitting the generated print data to a printer designated as a device for printing, using a communication function of the OS 21.

The supporting program 42 consists of a single program or a group of programs that execute processing based on an instruction received from the OS 21 in association with the processing executed by the universal printing program 41, and that support control of target hardware. The supporting program 42 is provided for the model of the printer 2 connected to the PC 1, for example, by the vendor of the printer 2. The universal printing program 41 activates the supporting program 42 for the printer 2 based on a specific condition. The specific condition may be, for example, the designation of the printer 2 as a device for printing, the reception of an instruction to specify advanced print settings while the printer 2 is designated, or the reception of an instruction to cause the printer 2 to perform printing. The supporting program 42 may be, for example, a Print Support Application (“PSA”) or a Hardware Support Application (“HSA”).

In one example, the supporting program 42 may be a combination of a plurality of programs that receive execution commands, respectively. In another example, the supporting program 42 may be a single program configured to execute different types of processing based on received commands. Supporting programs may be prepared for different types of printers by a printer vendor. For example, one supporting program may be for inkjet printers and another supporting program may be for laser printers. Supporting programs may be prepared not only for types of printers but also for different models of printer or different series of printer models.

For example, when a particular printer is connected to the PC 1 for the first time, the OS 21 of the PC 1 may download a supporting program appropriate for the type or model of the printer from a server of the vendor of the printer, and install the supporting program on the PC 1. The OS 21 stores identification data of the installed supporting program into the memory 12 in association with printer data of the newly connected printer.

The editing application 43 may be, for example, a program for creating and editing image data and/or document data. The editing application 43 may be, for example, Microsoft Word or Microsoft PowerPoint developed by Microsoft or may be a program provided by the vendor of the printer 2. Microsoft, Microsoft PowerPoint, and Microsoft Word are trademarks of the Microsoft group of companies. The editing application 43 may receive, via the user IF 13, for example, a print execution instruction to cause the printer 2 to perform printing. The editing application 43 is not limited to programs for creating and editing data, and may also include programs that have a function of receiving instructions to display or print various types of information, such as map information or web pages, in response to a user's request.

As illustrated in FIG. 1, the PC 1 of the illustrative embodiment is connected to the printer 2 via the communication IF 14. The printer 2 has at least a printing function and a communication function. For example, in response to receiving print data from the PC 1, the printer 2 may perform printing based on the received print data. The printer 2 of the illustrative embodiment is a color printer. In other embodiments, for example, the printer 2 may be a monochrome printer.

The printer 2 stores information that can be provided to an external device such as the PC 1. Examples of the information that can be provided to the external device include error screen information 4 and troubleshooting screen information 5. The error screen information 4 and the troubleshooting screen information 5 will be described later.

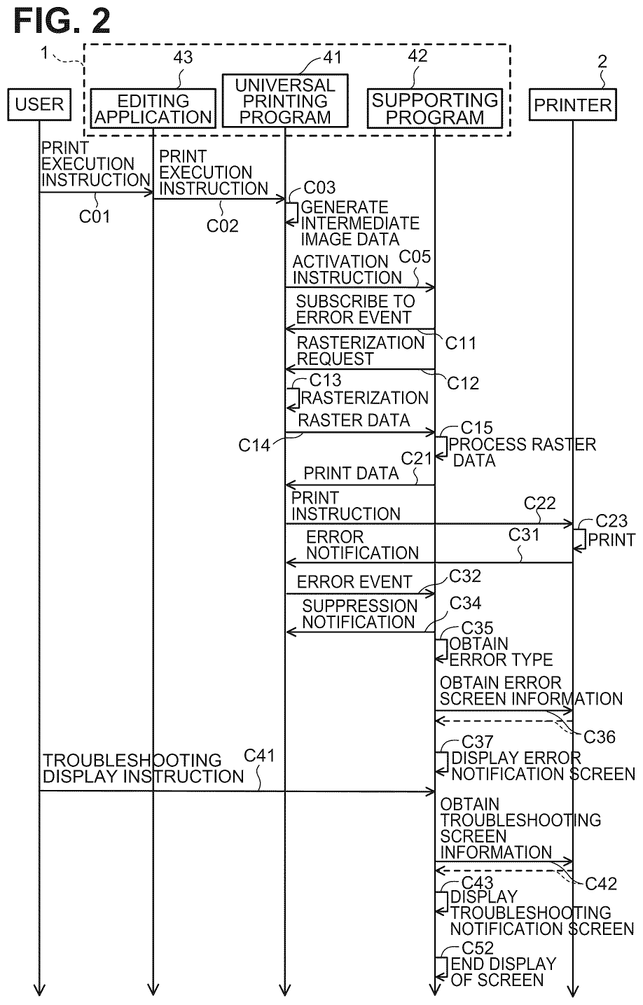

Next, a print execution procedure for causing the printer 2 to perform printing will be described with reference to FIG. 2. Here, as an example, the print execution procedure will be described in a case where the PC 1 designates the printer 2, which is a color printer, to perform printing.

Processing executed in each step in the illustrative embodiment essentially indicates processing executed by the CPU 11 in accordance with instructions written in a specific program, such as the supporting program 42. Processing executed by the CPU 11 also includes control of hardware using APIs of the OS 21. In the disclosure, a description will be provided on operations of the programs. A detailed description of the OS 21 will be omitted. The terms referring to coming into possession are used as a concept that does not require necessarily a request to obtain that possession.

After finalizing the image to be printed and the print settings for the printer 2, the user provides a print execution instruction via the editing application 43 (C01). The editing application 43 can display an editing screen and a print settings screen. The editing application 43 receives instructions from the user to create or edit a document or image via the editing screen. In response to receiving a selection of a printing function via the editing screen, the editing application 43 displays the print settings screen. The editing application 43 allows the user to designate a printer to be used for printing or specify various parameters on the print settings screen. More specifically, for example, based on the user's selection of a “Print” button on the print settings screen, the editing application 43 determines that a print execution instruction for the universal printing program 41 has been received. The print execution instruction instructs the printer 2 to print the specified image.

The editing application 43 passes the details of the print execution instruction to the universal printing program 41 (C02). The universal printing program 41 thus obtains image data representing the image to be printed and the print settings, as the details of the print execution instruction, from the editing application 43.

The universal printing program 41 generates intermediate image data by converting the image data to an intermediate image data format based on the print settings received from the editing application 43 (C03). The image data included in the editing application 43 is of various types. The universal printing program 41 thus converts the received image data to intermediate image data suitable for generating print data. Nevertheless, in other embodiments, for example, when the received image data is in a suitable format, the generation of intermediate image data may be omitted, and the image data may be used as intermediate image data without any conversion.

Prior to generating the intermediate image data, the universal printing program 41 may activate the supporting program 42 for the designated device, which may be the printer 2, and notify that processing for a print job has been started. In a case where the supporting program 42 is activated by the universal printing program 41, the supporting program 42 is allowed to pass various instructions to be used in the generation of intermediate image data, to the universal printing program 41 as necessary.

After generating the intermediate image data, the universal printing program 41 activates the supporting program 42 (C05). The supporting program 42 may obtain the intermediate image data generated by the universal printing program 41 by requesting the intermediate image data from the universal printing program 41. Then, the supporting program 42 may modify the intermediate image data received from the universal printing program 41 or print settings information, based on the print settings received via the print settings screen.

The supporting program 42 subscribes to an error event from the universal printing program 41 (C11). An error event can be output from the universal printing program 41 when the universal printing program 41 receives an error notification from the printer 2 used for printing. The error notification indicates that an error has occurred. Subscribing to an error event from the universal printing program 41 enables the supporting program 42 to receive an error event from the universal printing program 41.

The timing for subscribing to an error event (refer to step C11) can be at any time after the supporting program 42 is activated in response to a print instruction (i.e., after the supporting program 42 receives an activation instruction in step C05) and before the supporting program 42 executes a printing process (i.e., before the supporting program 42 outputs print data in step C21). In the illustrative embodiment, the supporting program 42 subscribes to an error event from the universal printing program 41 every time a print instruction is provided. Nevertheless, if the universal printing program 41 can maintain the error event subscription, the supporting program 42 may omit step C11.

The supporting program 42 passes the intermediate image data, and requests the universal printing program 41 to rasterize the intermediate image data (C12). The universal printing program 41 thus rasterizes the intermediate image data to generate raster data (C13). The raster data may be bitmap data. The universal printing program 41 then passes the generated raster data to the supporting program 42 (C14). The supporting program 42 thus obtains the raster data.

In other embodiments, for example, the supporting program 42 may perform rasterization instead of the universal printing program 41. More specifically, the supporting program 42 rasterizes the intermediate image data included in the received print execution instruction to generate raster data. Rasterization by the supporting program 42 may provide greater flexibility in rasterization than the universal printing program 41, which is likely to result in raster data that is suitable for printing by the printer 2. However, rasterization by the universal printing program 41 may enable the supporting program 42 to execute less processing, and may reduce the program size of the supporting program 42.

Subsequent to C14, the supporting program 42 processes the raster data obtained in step C14 as necessary, and encodes the processed raster image into PDL data to generate print data (C15). Subsequent to step C15, the supporting program 42 passes the generated print data to the universal printing program 41 and instructs the universal printing program 41 to transmit the print data to the printer 2 (C21). Step C21 is an example of “printing processing”.

The print data to be passed from the supporting program 42 to the universal printing program 41 in step C21 of FIG. 2 may be any type as long as the print data is in a format that can be printed by the printer 2. The PDL data generated by the supporting program 42 may be in a format that can be printed by printers in addition to models of the printer 2.

In response to the instruction received from the supporting program 42, the universal printing program 41 transmits the print data to the printer 2 and instructs the printer 2 to perform printing (C22). In response to the print instruction, the printer 2 performs printing based on the received print data (C23). Thus, a printed matter based on the print instruction output from the editing application 43 is outputted.

The printer 2 that performs printing notifies the universal printing program 41 of the printing result. For example, if an error occurs during printing and the printing fails, the printer 2 provides an error notification indicating the occurrence of the error to the universal printing program 41 (C31). Each error notification includes one of a plurality of error types. Examples of the error types include “Cover Open”, “Empty Consumable”, “Near Empty Consumable”, “Low Consumable”, “No Sheet”, “Sheet Jam”, “Full Output Tray”, and “Almost Full Output Tray”.

In response to receiving, from the printer 2, the error notification including an error type, the universal printing program 41 outputs an error event based on the established error event subscription (C32). For example, the universal printing program 41 outputs an error event including the error type included in the error notification.

In response to receiving the error event from the universal printing program 41 in step C32, the supporting program 42 passes a suppression notification to the universal printing program 41 to enable an error notification suppression setting in the universal printing program 41 (C34). The error notification suppression setting may specify that error notifications are unnecessary. Step C34 is an example of “setting processing”.

The universal printing program 41 can automatically display an error notification screen on the user IF 13 to notify the occurrence of an error in response to receiving an error notification from the printer 2. Nevertheless, the universal printing program 41 might not identify the error type included in the error notification. In that case, the universal printing program 41 displays an error notification screen including general information, and therefore, the details of the error cannot be notified via the error notification screen. On the other hand, as described later, the supporting program 42 can identify the error type included by the printer 2, and therefore, the details of the error can be notified via the error notification screen by using the supporting program 42.

When the error notification suppression setting is not enabled, the universal printing program 41 notifies an error automatically in response to receiving of an error notification. When the error notification suppression setting is enabled, the universal printing program 41 does not notify an error automatically in response to receiving of an error notification. Thus, enabling the error notification suppression setting in the universal printing program 41 may avoid duplicate error notifications from both the universal printing program 41 and the supporting program 42.

Subsequent to step C34, the supporting program 42 obtains the error type included in the error event received from the universal printing program 41 (C35). Step C35 is an example of “error type obtaining processing”. The supporting program 42 can obtain the error type without communicating with the printer 2.

In one example, the error notification may include an error code. Each error code uniquely identifies an error type. In this case, the universal printing program 41 may output an error event corresponding to the error code. In this case, the supporting program 42 may obtain the error type by analyzing the type of the error event.

In other embodiments, for example, in a case where the error notification transmitted from the printer 2 includes an error type but the universal printing program 41 outputs an error event that does not specify the error type, the supporting program 42 may obtain, from the universal printing program 41, the error type included in the error notification. In this case, also, the supporting program 42 can obtain the error type from the universal printing program 41 without communicating with the printer 2.

In another example, in a case where the error notification transmitted from the printer 2 does not include the error type, the supporting program 42 may obtain the error type from the printer 2. In this case, the supporting program 42 may obtain the error type from the printer 2 via the universal printing program 41. At this time, the universal printing program 41 communicates with the printer 2 via the OS 21 in compliance with, for example, the Internet Printing Protocol (“IPP”). The supporting program 42 may obtain the error type directly from the printer 2, using, for example, the Management Information Base (“MIB”).

The supporting program 42 obtains error screen information 4 based on the error type obtained in step C35 and the printer model designated by the print instruction (C36). The error screen information 4 is used when an error notification screen that notifies an error is displayed. The error screen information 4 is customized for each error type in accordance with the printer model. The error screen information 4 includes, for example, a layout indicating an arrangement of images and text, error information indicating error details, and image data supported by the printer model. Step C36 is an example of “error screen obtaining processing”.

In the illustrative embodiment, the error screen information 4 for the printer model is stored in each printer by a printer vendor. The supporting program 42 obtains the error screen information 4 for the error type obtained in step C35, from the printer 2 designated by the print instruction. As described above, the error screen information 4 for each error type is stored in the printer 2. When an error is notified, the supporting program 42 obtains appropriate error screen information 4 from the printer 2, thereby reducing the program size of the supporting program 42. Further, the supporting program 42 can display, on the display 13a of the PC 1, a detailed message appropriate to the printer 2.

The error screen information 4 may be stored in an external device such as a server. For example, the server may be managed by the printer vendor, and may store all error screen information 4 provided by the printer vendor. In this case, the supporting program 42 requests the server to transmit appropriate error screen information 4 using, for example, the communication IF 14. The request includes the model of the printer 2 and the obtained error type. The server retrieves error screen information 4 based on the model and error type included in the request, and transmits the retrieved error screen information 4 to the PC 1. The supporting program 42 thus receives the appropriate error screen information 4 from the server using the communication IF 14. As described above, error screen information 4 for each error type is stored in an external device such as a server. When an error is notified, the supporting program 42 obtains appropriate error screen information 4 from the external device, thereby reducing the program size of the supporting program 42. Further, such a configuration may allow the error screen information 4 or the error notification screen to be changed without modifying the supporting program 42.

The error screen information 4 may be stored in a storage area for the supporting program 42 provided in the memory 12. In this case, the supporting program 42 stores error screen information 4 for the printer model supported by the supporting program 42. The supporting program 42 obtains, from the memory 12, error screen information 4 based on the printer model designated by the print instruction and the error type obtained in step C35. Such a configuration may enable the supporting program 42 to obtain appropriate error screen information 4 and display an error notification screen without communicating with the printer 2 or an external device such as a server.

Even when error screen information 4 is stored in the memory 12, if the supporting program 42 cannot identify the error type for some reason, the supporting program 42 cannot obtain error screen information 4 for the error type from the memory 12. If such a case occurs, the supporting program 42 may pass the type of an unknown error to an external device such as a server to obtain appropriate error screen information 4. That is, the way in which the supporting program 42 obtains error screen information 4 may be varied according to the situation at the time of obtainment.

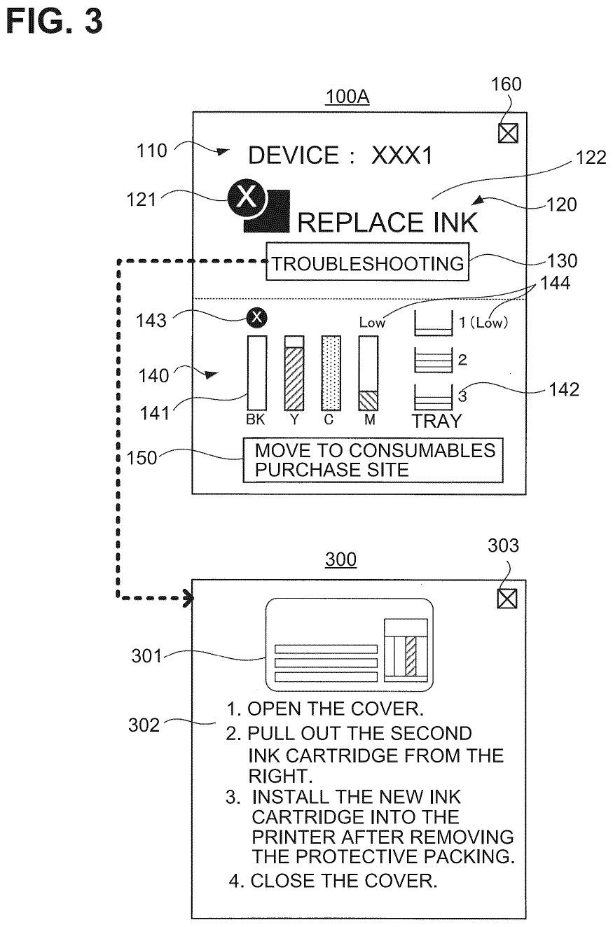

Subsequent to step C36, the supporting program 42 displays an error notification screen on the display 13a of the user IF 13 based on the error screen information 4 obtained in step C36 (C37). As described above, error screen information 4 is customized for each error type. Therefore, the supporting program 42 can display, on the display 13a, an error notification screen whose content differs depending on the error type. Step C37 is an example of “error notification processing”. FIGS. 3, 4, and 5 illustrate examples of the error notification screen.

For example, in a case where the supporting program 42 obtains the error screen information 4 based on an ink empty error in step C36, the supporting program 42 displays an error notification screen 100A of FIG. 3 on the display 13a. The error notification screen 100A includes a device display area 110, a print job result display area 120, a troubleshooting button 130, a status display area 140, a consumables purchase site display button 150, and a close button 160.

In the device display area 110, the device name “XXX1” of the printer 2 designated by the print instruction is displayed. The print job result display area 120 includes an error mark 121 and a message 122. The error mark 121 may indicate that a print error has occurred. The message 122 may prompt ink replacement. Such indications, including the error mark 121 and the message 122, may enable the user to recognize that the current print job in the printer 2 has failed due to insufficient ink, even when the user is not physically near the printer 2.

The troubleshooting button 130 is used to display troubleshooting for the error type. The troubleshooting button 130 is an example of a UI element. The steps executed in response to an operation on the troubleshooting button 130 will be described later.

In the status display area 140, status information obtained from the printer 2 is displayed. For example, the supporting program 42 receives status information from the printer 2 when obtaining the error screen information in step C36. The status information includes, for example, remaining amount information indicating a status or remaining amount of a consumable, such as ink or sheets. The status display area 140 includes images 141 and 142. For example, the image 141 may indicate an ink status for each color. The image 142 may indicate a sheet status for each tray. The status display area 140 may further include, for example, an empty mark 143 and a Low mark 144. The empty mark 143 is added to consumables whose status is near empty, and the Low mark 144 is added to consumables whose status is low. Such indications in the status display area 140 may thus enable the user to identify which color ink cartridge needs to be replaced or which tray has run out of sheets. The user can also identify an ink cartridge that will be soon need to be replaced and a sheet tray that will soon need to be refilled.

The consumables purchase site display button 150 is another example of the UI element. The consumables purchase site display button 150 is used to access a web page serving a purchase screen that allows the user to order consumables. The consumables purchase site display button 150 is associated with a URL indicating the web page serving the purchase screen. In response to the user operating the consumables purchase site display button 150 on the user IF 13, the supporting program 42 passes the URL to a browser. The browser is provided with the purchase screen from a server that manages the web page indicated by the URL, and displays the purchase screen. If the supporting program 42 has a browser function, the supporting program 42 may directly access the server based on the URL to display the purchase screen provided by the server.

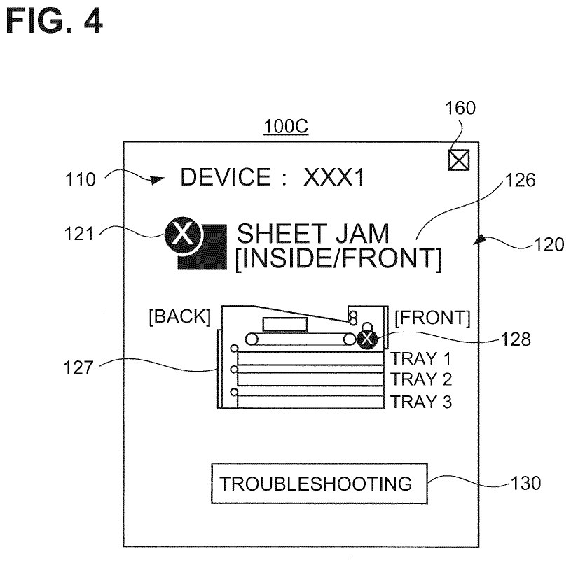

For example, in a case where the supporting program 42 obtains the error screen information 4 based on a sheet jam error in step C36, the supporting program 42 displays an error notification screen 100C of FIG. 4 on the display 13a. The error notification screen 100C includes the device display area 110, the print job result display area 120, the troubleshooting button 130, and the close button 160. Since checking the consumable statuses and ordering consumables do not needed to troubleshoot the sheet jam error, the error notification screen 100C might not include the status display area 140 and the consumables purchase site display button 150.

The error notification screen 100C has indications different from the error notification screen 100A, in the print job result display area 120. More specifically, the error notification screen 100C includes the error mark 121 and a message 126. The message 126 may indicate an error type “Sheet Jam”, and the location where the error has occurred “Inside/Front”. The error notification screen 100C may further include an image 127 and a location mark 128. The image 127 may represent a printer based on the model of the printer 2. The location mark 128 may indicate the location where the sheet jam has occurred. Such indications, including the error mark 121 and the message 126, may enable the user to recognize that the current print job in the printer 2 has failed due to sheet jam, and to confirm the situation of the sheet jam, even when the user is not physically near the printer 2. Further, the image 127 and the location mark 128 may enable the user to clearly identify the situation of the sheet jam, thereby facilitating clearing of the sheet jam.

As described above, the error screen information 4 can be customized for each printer model. Therefore, the supporting program 42 can display, on the display 13a, an error notification screen whose content differs for the same error type depending on the printer model. Printers include models with an LCD panel that can display detailed information and models without such an LCD panel. When a sheet jam occurs in a printer model without such an LCD panel, the supporting program 42 may display, for example, the error notification screen 100C of FIG. 4 on the display 13a of the PC 1.

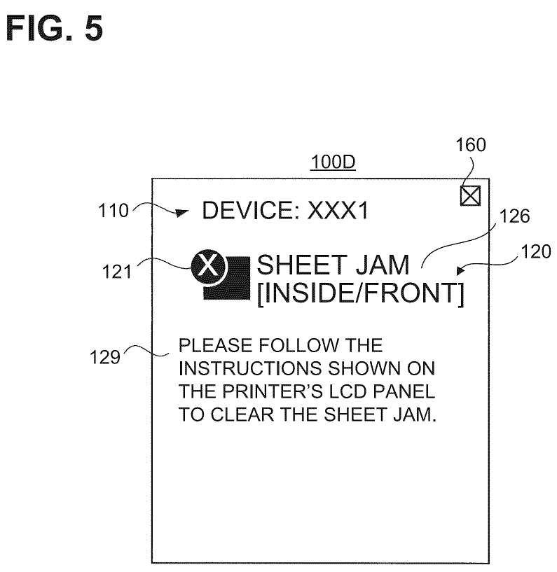

When a sheet jam occurs in a printer model with such an LCD panel, the supporting program 42 may display, for example, an error notification screen 100D of FIG. 5 on the display 13a of the PC 1. Nevertheless, if a printer has an LCD panel, referring to the LCD panel on the printer may be more convenient for the user when clearing a sheet jam, compared to looking at the display 13a of the PC 1. Therefore, instead of displaying the image 127 and the location mark 128 as illustrated in FIG. 4, the error notification screen 100D includes a message 129 such as “Please follow the instructions shown on the printer's LCD panel to clear the sheet jam,” in order to prompt the user to go to the location where the printer is installed. Therefore, the supporting program 42 can provide a notification appropriate to the printer model.

Referring back to FIG. 2, for example, in response to the troubleshooting button 130 of the error notification screen 100A in FIG. 3 being operated via the user IF 13, the supporting program 42 receives a troubleshooting display instruction (C41) and obtains troubleshooting screen information 5 (C42). The troubleshooting button 130 is associated with a storage location of the troubleshooting screen information 5 for each error type. The supporting program 42 accesses the storage location associated with the troubleshooting button 130 to obtain the troubleshooting screen information 5. Step C42 is another example of the “error screen obtaining processing”.

The troubleshooting screen information 5 is used when a troubleshooting notification screen that provides troubleshooting for each error is displayed. The troubleshooting may be provided for each printer model. For example, the troubleshooting screen information 5 may be composed solely of text data, solely of multiple image data, or a combination of text data and image data to represent troubleshooting steps. The troubleshooting screen information 5 may be moving image data.

In the illustrative embodiment, the troubleshooting screen information 5 is stored in each printer according to its model by the printer vendor. In response to the troubleshooting button 130 being operated, the supporting program 42 obtains the troubleshooting screen information 5 from the printer 2. Storing the troubleshooting screen information 5 in the printer 2 may reduce the program size of the supporting program 42.

The troubleshooting screen information 5 may be stored in an external device such as a server. In this case, the supporting program 42 accesses the server to obtain the troubleshooting screen information 5 using the communication IF 14. Storing the troubleshooting screen information 5 in the server may reduce the program size of the supporting program 42. Further, such a configuration may allow the troubleshooting screen information 5 or the troubleshooting notification screen to be changed without modifying the supporting program 42.

The troubleshooting screen information 5 may be stored in the storage area for the supporting program 42 provided in the memory 12. In this case, the supporting program 42 retrieves the troubleshooting screen information 5 from the storage area for the supporting program 42. Such a configuration may enable the supporting program 42 to obtain appropriate troubleshooting screen information 5 and display a troubleshooting notification screen without communicating with an external device.

The troubleshooting screen information 5 and the error screen information 4 can be stored in respective different locations. For example, the error screen information 4 may be stored in the storage area for the supporting program 42 provided in the memory 12, and the troubleshooting screen information 5 may be stored in the server.

The supporting program 42 displays a troubleshooting notification screen on the display 13a based on the troubleshooting screen information 5 obtained in step C42 (C43). The troubleshooting notification screen may be displayed separately from the error notification screen, or may be incorporated into the error notification screen as a single screen. Step C43 is an example of “troubleshooting notification processing”. FIG. 3 illustrates an example of the troubleshooting notification screen.

For example, the troubleshooting notification screen 300 in FIG. 3 is displayed in response to the troubleshooting button 130 on the error notification screen 100A for an insufficient ink error being operated. The troubleshooting notification screen 300 is displayed on the display 13a separately from the error notification screen 100A. The troubleshooting notification screen 300 includes, for example, an image 301 and a text 302. The image 301 may indicate the location of an ink cartridge that needs to be replaced. The text 302 may indicate the steps for ink replacement. Such indications may enable the user to understand how to resolve the insufficient ink error, thereby prompting the user to replace the ink cartridge. In the illustrative embodiment, the troubleshooting button 130 is included in the error notification screen 100A. In response to the troubleshooting button 130 being operated, the troubleshooting notification screen 300 is displayed separately from the error notification screen 100A. This may thus enable the notification contents to be simple, thereby enabling the user to readily understand how to resolve the error.

In response to an operation on a close button 303 of the troubleshooting notification screen 300 or on the close button 160 of the error notification screen 100A via the user IF 13, the supporting program 42 terminates the display of the troubleshooting notification screen 300 or the error notification screen 100A.

In the illustrative embodiment, the supporting program 42 controls the display of the error notification screen 100A and the troubleshooting notification screen 300. Nevertheless, in other embodiments, for example, the OS 21 may control the display of the error notification screen 100A and the troubleshooting notification screen 300 in response to a request from the supporting program 42.

As described above in detail, when an error event is output from the universal printing program 41 in response to a print instruction, the supporting program 42 obtains the type of the error that has occurred in the printer 2 and causes the PC 1 to display the error notification screen 100A appropriate to the error type on the user IF 13. The supporting program 42 thus might not need to monitor the printer 2 after transmission of print data. That is, the supporting program 42 performs communication only when an error occurs and might not need to repeatedly obtain the printer status after transmission of a print instruction. This may thus lighten the workload on the supporting program 42 when the supporting program 42 notifies an error that has occurred in the printer 2.

### Second Illustrative Embodiment

Next, a second illustrative embodiment will be described. In the second illustrative embodiment, the supporting program 42 obtains the error screen information 4 and the troubleshooting screen information 5 simultaneously. This point differs from the first illustrative embodiment, in which the error screen information 4 and the troubleshooting screen information 5 are obtained at different timings, while other aspects are common to the first illustrative embodiment. Hereinafter, the description will focus on the differences from the first illustrative embodiment, and the configurations and processes common to the first illustrative embodiment will be denoted by the same reference numerals and omitted from description as appropriate.

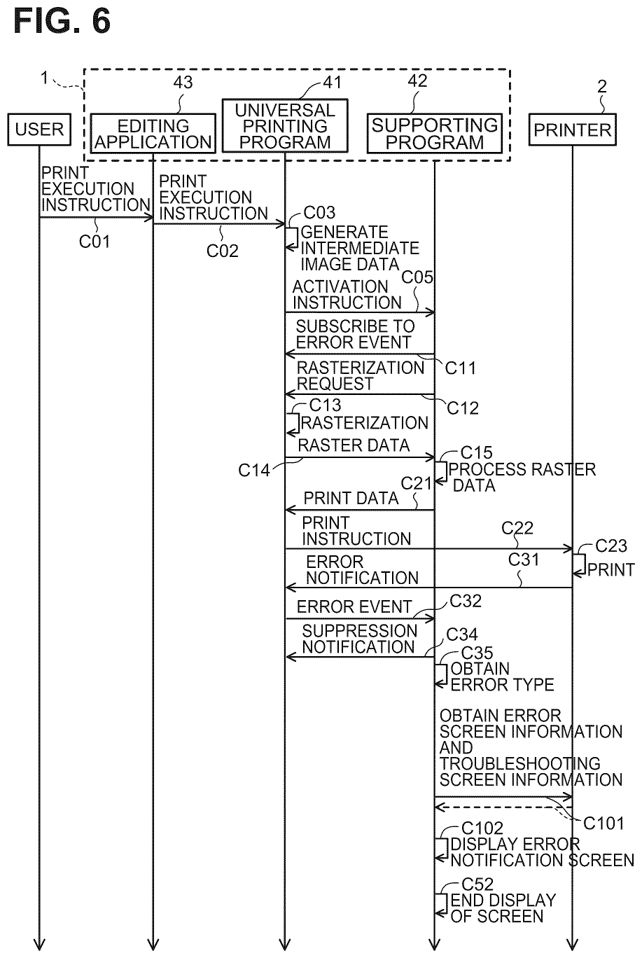

As illustrated in FIG. 6, after the supporting program 42 obtains the error type (C35), the supporting program 42 obtains error screen information 4 and troubleshooting screen information 5 simultaneously (C101). The error screen information 4 and the troubleshooting screen information 5 can be stored in the same location or in respective different locations. Step C101 is another example of the “error screen obtaining processing”.

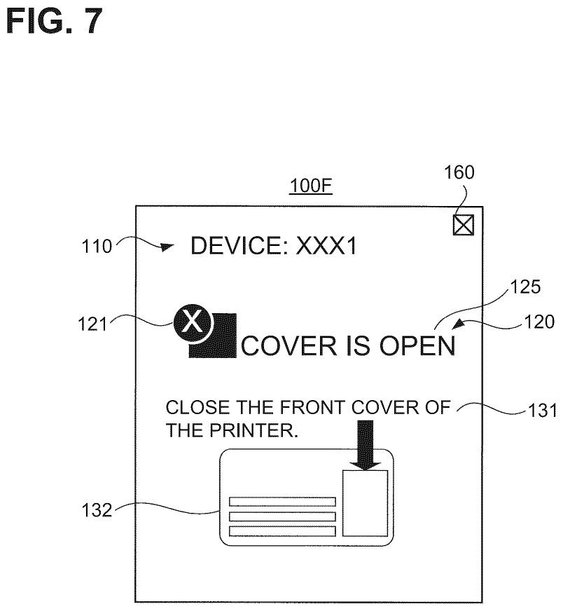

The supporting program 42 displays an error notification screen on the display 13a of the PC 1 based on the error screen information 4 and the troubleshooting screen information 5 obtained in step C101 (C102). The error notification screen includes the error type and the troubleshooting for the error type. Step C102 is another example of the “error notification processing”. FIG. 7 illustrates another example of the error notification screen.

For example, the user opens the cover of the printer 2 and performs ink replacement. If the cover of the printer 2 is not completely closed after ink replacement, the printer 2 transmits an error notification including an error type “Cover is Open” to the universal printing program 41. In this case, the supporting program 42 obtains the error screen information 4 and troubleshooting screen information 5 based on the cover open error, and displays an error notification screen 100F of FIG. 7 on the display 13a of the PC 1.

For example, the error notification screen 100F includes the device display area 110, the print job result display area 120, a troubleshooting message 131, an image 132, and the close button 160.

The error notification screen 100F further includes the error mark 121 and a message 125 indicating the error type “Cover is Open”. The troubleshooting message 131 included in the error notification screen 100F may indicate how to resolve the cover open error, for example, “Close the front cover of the printer”. The error notification screen 100F includes the image 132 that may indicate the location of the front cover where the error has occurred.

In the second illustrative embodiment, the supporting program 42 notifies the user of not only the error type (i.e., the message 125) but also the troubleshooting for the error type (i.e., the troubleshooting message 131 and the image 132) simultaneously, via the error notification screen 100F. This may enable the user to understand both the error type and the troubleshooting for the error, thereby enabling the user to address the error appropriately.

While the disclosure has been described in detail with reference to the specific embodiment thereof, this is merely an example, and various changes, arrangements and modifications may be applied therein without departing from the spirit and scope of the disclosure. Any apparatuses or devices having a printing function may be connected to the PC 1. Examples of such apparatuses or devices include multifunction peripherals, copying machines, and facsimile machines. A plurality of printers, for example, two or more printers may be connected to the PC 1.

Instead of the troubleshooting button 130 and the consumables purchase site display button 150, the error notification screen 100A in FIG. 3 may include links to the corresponding site URLs, or may simply include the corresponding site URLs as text. Nevertheless, it is preferable that the error notification screen 100A includes the troubleshooting button 130 and the consumables purchase site display button 150. Those buttons may enable the user to readily display troubleshooting or a purchase screen.

The error screen information 4 may be common to various printer models. Nevertheless, it is preferable that error screen information 4 specific to each printer model is provided, even for the same error type. This may enable notifications to be provided according to the printer model.

Step C34 in FIG. 2 may be omitted. In other words, both the supporting program 42 and the universal printing program 41 may notify the user of an insufficient consumable error. However, it is preferable that if it is normal for the universal printing program 41 to notify errors, the supporting program 42 passes a suppression notification to the universal printing program 41 and enables the error notification suppression setting in the universal printing program 41. This may thus avoid duplicate error notifications regarding an insufficient consumable error from both the universal printing program 41 and the supporting program 42.

As illustrated in FIG. 6, even when the error screen information 4 and the troubleshooting screen information 5 are obtained simultaneously, the error notification screen and the troubleshooting notification screen may be displayed as separate screens. In this case, for example, as illustrated in FIG. 3, the troubleshooting notification screen may be displayed in response to an operation on the UI element included in the error notification screen, or the error notification screen and the troubleshooting notification screen may be simultaneously displayed side by side.

In the illustrative embodiment, the description has been provided on only the printing operation in which the supporting program 42 is involved. However, the supporting program 42 may be involved in another operation in addition to the printing operation. Any program may be applicable instead of the supporting program 42, as long as the program receives an instruction from the OS 21 or the universal printing program 41 when printing is performed using the universal printing program 41. For example, the alternative program may be a print workflow application (PrintWorkflow) whose specification has been disclosed by Microsoft Corporation.

In any flowchart disclosed in the illustrative embodiment, steps may be executed in a different order or in parallel, as long as no contradiction occurs in the contents of the procedures.

The processing in all steps disclosed in the illustrative embodiment may be executed by hardware, such as a single CPU, multiple CPUs, an ASIC, or a combination thereof. The processing in all steps disclosed in the embodiment may be implemented in various aspects such as a recording medium storing a computer-readable program for executing the processing, or a method.

What is claimed is:

1. A non-transitory computer-readable storage medium for an information processing device, the information processing device including a controller, the non-transitory computer-readable storage medium storing computer-executable instructions for implementing a supporting program for a printer connectable to the information processing device, wherein the information processing device has an operating system including a universal printing program, the information processing device is incorporated with an application program, the supporting program that, when executed by the controller, causes the information processing device to perform:
in response to the universal printing program receiving, from the application program, a print instruction that causes the printer to print an image to be printed,
printing processing of causing the printer to print the image to be printed;
receiving processing of receiving an error event from the universal printing program, the error event being output by the universal printing program in response to the universal printing program receiving an error notification from the printer after the printing;
in response to receiving the error event from the universal printing program, error type obtaining processing of obtaining an error type, the error type indicating an error that has occurred in the printer, the error type being one of a plurality of error types;
error screen obtaining processing of obtaining error screen information based on the error type; and
error notification processing of displaying, on a user interface of the information processing device, an error notification screen based on the error screen information.

2. The non-transitory computer readable storage medium according to claim 1,
wherein the error notification received from the printer by the universal printing program includes one of the plurality of error types,
wherein the error type obtaining processing includes obtaining the error type that is included in the error notification received from the printer by the universal printing program.

3. The non-transitory computer readable storage medium according to claim 1,
wherein the error screen obtaining processing includes obtaining the error screen information based on the error type and troubleshooting for the error type, and
wherein the error notification processing includes displaying the error notification screen on the user interface based on the obtained error screen information, the error notification screen including the error type and the troubleshooting.

4. The non-transitory computer readable storage medium according to claim 1,
wherein the supporting program, when executed by the controller, causes the information processing device to perform:
troubleshooting screen obtaining processing of obtaining troubleshooting screen information based on troubleshooting for the error type; and
troubleshooting notification processing of displaying, on a user interface of the information processing device, a troubleshooting notification screen based on the troubleshooting screen information.

5. The non-transitory computer readable storage medium according to claim 4,
wherein the error notification screen includes a UI element, and
wherein the supporting program, when executed by the controller, causes the information processing device to perform:
in response to the UI element being operated, performing the troubleshooting screen obtaining processing and the troubleshooting notification processing.

6. The non-transitory computer readable storage medium according to claim 1,
wherein an external device stores error screen information for each of the plurality of error types, and
wherein the error screen obtaining processing includes obtaining, from the external device, the error screen information based on the obtained error type.

7. The non-transitory computer readable storage medium according to claim 1,
wherein the printer stores error screen information for each of the plurality of error types, and
wherein the error screen obtaining processing includes obtaining, from the printer, the error screen information based on the obtained error type.

8. The non-transitory computer readable storage medium according to claim 1,
wherein the error screen obtaining processing includes obtaining the error screen information based on the obtained error type and a model of the printer, and
wherein the error screen information varies according to the model of the printer even for the same error type.

9. The non-transitory computer readable storage medium according to claim 1,
wherein the supporting program, when executed by the controller, causes the information processing device to perform:
in response to receiving the error event from the universal printing program, setting processing of enabling an error notification suppression setting in the universal printing program, wherein:
when the error notification suppression setting is disabled, the universal printing program notifies an error in response to receiving the error notification from the printer; and
when the error notification suppression setting is enabled, the universal printing program does not notify an error in response to receiving the error notification from the printer.

10. A non-transitory computer-readable storage medium for an information processing device, the information processing device including a controller, the non-transitory computer-readable storage medium storing computer-executable instructions for implementing a supporting program, wherein the information processing device has an operating system including a universal printing program, the supporting program that, when executed by the controller, causes the information processing device to perform:
in response to receiving an image to be printed from the universal printing program, causing a printer to print the image to be printed;
receiving an error event from the universal printing program, the error event being output by the universal printing program in response to the universal printing program receiving an error notification from the printer after the printing; and
in response to receiving the error event, obtaining an error type, the error type indicating an error that has occurred in the printer, the error type being one of a plurality of error types;
obtaining error screen information based on the error type; and
displaying, on a user interface of the information processing device, an error notification screen based on the error screen information.

11. The non-transitory computer readable storage medium according to claim 10,
wherein the error notification received from the printer by the universal printing program includes one of the plurality of error types,
wherein the obtaining the error type includes obtaining the error type that is included in the error notification received from the printer by the universal printing program.

12. The non-transitory computer readable storage medium according to claim 10,
wherein the obtaining the error screen information includes obtaining the error screen information based on the error type and troubleshooting for the error type, and
wherein the displaying the error notification includes displaying the error notification screen on the user interface based on the obtained error screen information, the error notification screen including the error type and the troubleshooting.

13. The non-transitory computer readable storage medium according to claim 10,
wherein the supporting program, when executed by the controller, causes the information processing device to perform:
obtaining troubleshooting screen information based on troubleshooting for the error type; and
displaying, on a user interface of the information processing device, a troubleshooting notification screen based on the troubleshooting screen information.

14. The non-transitory computer readable storage medium according to claim 13,
wherein the error notification screen includes a UI element, and
wherein the supporting program, when executed by the controller, causes the information processing device to perform:
in response to the UI element being operated, performing the obtaining troubleshooting screen information and the displaying the troubleshooting notification screen.

15. The non-transitory computer readable storage medium according to claim 10,
wherein an external device stores error screen information for each of the plurality of error types, and
wherein the obtaining the error screen information includes obtaining, from the external device, the error screen information based on the obtained error type.

16. The non-transitory computer readable storage medium according to claim 10,
wherein the printer stores error screen information for each of the plurality of error types, and
wherein the obtaining error screen information includes obtaining, from the printer, the error screen information based on the obtained error type.

17. The non-transitory computer readable storage medium according to claim 10,
wherein the obtaining error screen information includes obtaining the error screen information based on the obtained error type and a model of the printer, and
wherein the error screen information varies according to the model of the printer even for the same error type.

18. The non-transitory computer readable storage medium according to claim 10,
wherein the supporting program, when executed by the controller, causes the information processing device to perform:
in response to receiving the error event from the universal printing program, enabling an error notification suppression setting in the universal printing program, wherein:
when the error notification suppression setting is disabled, the universal printing program notifies an error in response to receiving the error notification from the printer; and
when the error notification suppression setting is enabled, the universal printing program does not notify an error in response to receiving the error notification from the printer.
